(19) United States
(12) Patent Application Publication
(10) Pub. No.: US 2026/0241245 A1
(43) Pub. Date: Aug. 20, 2026

(54) PICKLEBALL PADDLE WITH A MID-LAYER STRUCTURE

(71) Applicant: Sport Squad, Inc., North Bethesda, MD (US)

(72) Inventors: Fabio Kachiwazaki, São Paulo (BR); Richard Lee, North Bethesda, MD (US); Caleb Will Dyer, Cumming, GA (US); Austin Kim, Columbia, MD (US)

(21) Appl. No.: 19/533,571

(22) Filed: Feb. 9, 2026

Related U.S. Application Data
(60) Provisional application No. 63/767,270, filed on Mar. 5, 2025.
(60) Provisional application No. 63/760,420, filed on Feb. 19, 2025.

(51) Int. Cl. A63B 59/42; A63B 102/08

(52) U.S. Cl. CPC A63B 59/42; A63B 2102/08

(57) ABSTRACT

The present teachings may be directed to game paddles such as pickleball paddles. Specifically, the present teachings may include a paddle with a mid-layer structure—e.g., a paddle including a frame, a plurality of core portions, and a mid-layer disposed between the core portions. A paddle or kit according to the present teachings may also or instead include removable and replaceable core portions, linking members, and/or playing surfaces that can be coupled to the core portions or otherwise. The mid-layer structure of the present teachings may provide a means for customizing the paddle’s performance characteristics, e.g., through the mid-layer’s configuration and/or through interchangeability provided by a mid-layer. This can be useful for, inter alia, adjusting the paddle’s stiffness, weight distribution, and overall feel, as well as enabling easy replacement or modification of individual components to extend the paddle’s lifespan or adapt its properties for different playing styles or conditions.

### CROSS-REFERENCE TO RELATED APPLICATIONS

This application claims priority to U.S. Provisional Pat. App. No. 63/760,420 filed on February 19, 2025, and U.S. Provisional Pat. App. No. 63/767,270 filed on March 5, 2025. Each of the foregoing applications is hereby incorporated by reference in its entirety.

### FIELD

The present disclosure generally relates to game paddles and the like—e.g., pickleball paddles—as well as methods for making and using the same.

### BACKGROUND

Paddles for paddle sports have been used for ages. The term “paddle” typically refers to equipment where the ball striking surface does not include strings (e.g., a tennis racket would not be considered a paddle). Paddles are used to play games such as pickleball, paddleball, table tennis, padel, and the like. In particular, pickleball is a paddle sport that generally combines elements of tennis, badminton, and ping-pong. It is played on a court with similar dimensions to a badminton court and with a net dividing opposing sides. The game is played with a perforated plastic ball and solid paddles made of, for example, wood, graphite, and/or composite materials. In general, players use their paddles to hit the ball over the net, aiming to land the ball within the boundaries of the opposing side of the court. As the sport has evolved, so too has the equipment used by players, with paddle design becoming an area of particular focus.

Paddle construction typically includes a core material sandwiched between two surface layers, often with a frame surrounding the perimeter. The materials and design of these components can affect various aspects of paddle performance, including power, control, and feel. Players often seek paddles that offer a balance of these characteristics to suit their individual playing styles and preferences. As such, there is ongoing interest in paddle designs that can provide enhanced performance while adhering to the rules and regulations governing equipment in competitive play.

There remains a need for pickleball paddles with improved performance characteristics such as power, control, and feel.

### SUMMARY

The present teachings may be directed to game paddles such as pickleball paddles. Specifically, the present teachings may include a paddle with a mid-layer structure—e.g., a paddle including a frame, a plurality of core portions, and a mid-layer disposed between the core portions. A paddle or kit according to the present teachings may also or instead include removable and replaceable core portions, linking members, and/or playing surfaces that can be coupled to the core portions or other portions of the paddle. The mid-layer structure of the present teachings may provide a means for customizing the paddle’s performance characteristics, e.g., through the configuration of the mid-layer itself and/or through interchangeability of other paddle components made possible by providing a mid-layer. This can be useful for, inter alia, adjusting the paddle’s stiffness, weight distribution, energy transfer characteristics, vibration dampening, and overall feel, as well as enabling easy replacement or modification of individual components to extend the paddle’s lifespan or adapt its properties for different playing styles or conditions.

In an example aspect, a paddle disclosed herein includes: a frame; a first core portion on a front side of the paddle, the first core portion at least partially bounded by the frame; a second core portion on a back side of the paddle disposed opposite the front side, the second core portion at least partially bounded by the frame; and a mid-layer disposed between the first core portion and the second core portion, the mid-layer having one or more different properties than each of the first core portion and the second core portion.

Implementations of this example aspect, or any other example aspect described in this summary section or otherwise herein, may include one or more of the following features. The mid-layer may extend from the frame. The mid-layer may be made from one or more of the same materials as the frame. The frame may bound an entire perimeter of the paddle, and the mid-layer may be present within an entirety of an area bounded by the frame. The mid-layer may be bonded to the frame. The mid-layer may be present within a head portion of the paddle. The mid-layer may be present within an entirety of the head portion of the paddle. The mid-layer may be confined to the head portion of the paddle. The mid-layer may be present within a handle portion of the paddle. The mid-layer may be present within an entirety of the handle portion of the paddle. The mid-layer may be a continuous sheet of material. The mid-layer may include one or more voids. The mid-layer may include a mesh material. The mid-layer may include material disposed in a pattern defining the one or more voids. The mid-layer may be thinner than each of the first core portion and the second core portion. The mid-layer may be more rigid than each of the first core portion and the second core portion. The mid-layer may be more elastic than each of the first core portion and the second core portion. The mid-layer may comprise carbon fiber. The mid-layer may comprise at least one of rubber, plastic, and string. The mid-layer may comprise a plurality of strings in tension. The plurality of strings may extend from the frame. A gap may be formed between at least one of: (i) the first core portion and the frame, and (ii) the second core portion and the frame. A linking member may be disposed within at least a portion of the gap. The gap may be formed along each of the front side and the back side of the paddle, and a first linking member may be disposed in the gap on the front side of the paddle, and a second linking member may be disposed in the gap on the back side of the paddle. The first linking member and the second linking member may be substantially the same. The first linking member and the second linking member may be different. The gap may extend through each of the first core portion and the second core portion. A filler may be disposed within at least a portion of the gap. One or more of the first core portion and the second core portion may be removable and replaceable. One or more of the first core portion and the second core portion may be removably and replaceably coupled with the mid-layer. Coupling of one or more of the first core portion and the second core portion with the mid-layer may be provided by one or more of tape, adhesive, and magnetic attraction. Coupling of one or more of the first core portion and the second core portion with the mid-layer may be provided by mechanical means. One or more of the first core portion and the second core portion may define an exterior surface structurally configured to be a playing surface for the paddle. The mid-layer may provide a predetermined stiffness for the paddle that permits one or more of the first core portion and the second core portion to be the playing surface for the paddle.

In an example aspect, a method of forming a paddle disclosed herein includes: forming a paddle structure including: a frame; a mid-layer bounded by the frame and disposed at least partially along a plane intersecting opposing sides of the frame, the mid-layer defining a first engagement surface along a front side of the paddle structure and a second engagement surface along a back side of the paddle structure; a first cavity along the front side of the paddle structure, the first cavity at least partially bounded by the frame and the first engagement surface of the mid-layer; and a second cavity along the back side of the paddle structure, the second cavity at least partially bounded by the frame and the second engagement surface of the mid-layer; inserting a first core portion within the first cavity and engaging the first core portion to the first engagement surface of the mid-layer; and inserting a second core portion within the second cavity and engaging the second core portion to the second engagement surface of the mid-layer.

Implementations of this example aspect, or any other example aspect described in this summary section or otherwise herein, may include one or more of the following features. The method may include coupling a playing surface to one or more of the first core portion and the second core portion. The method may include inserting a linking member within a gap formed between at least one of: the first core portion and the frame, and the second core portion and the frame.

In an example aspect, a kit for a paddle disclosed herein includes: a paddle structure comprising a frame and a mid-layer bounded by the frame, the mid-layer disposed along a plane intersecting opposing sides of the frame, and the mid-layer thinner than the frame such that it defines a first cavity having a first engagement surface along a front side of the paddle structure and a second cavity having a second engagement surface along a back side of the paddle structure; a first core portion insertable within at least the first cavity and engageable with the first engagement surface; and a second core portion insertable within at least the second cavity and engageable with the second engagement surface.

Implementations of this example aspect, or any other example aspect described in this summary section or otherwise herein, may include one or more of the following features. The first core portion and the second core portion may be substantially the same. The first core portion and the second core portion may be different. One or more of the first core portion and the second core portion may define a playing surface for the paddle. The kit may include one or more playing surfaces. The one or more playing surfaces may be couplable to at least one of the first core portion and the second core portion. The one or more playing surfaces may be removably and replaceably coupled to at least one of the first core portion and the second core portion. The first cavity and the second cavity may be wholly disposed within a head portion of the paddle structure. The frame may enclose the head portion of the paddle structure.

These and other features, aspects, and advantages of the present teachings will become better understood with reference to the following description, examples, and appended claims.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 shows a pickleball paddle, according to a representative example.

FIG. 2 shows an exploded view of the pickleball paddle of FIG. 1, according to a representative example.

FIG. 3A shows a plan view of the pickleball paddle of FIG. 1, according to a representative example.

FIG. 3B shows a cross-sectional view along the line 3B-3B of FIG. 3A, according to a representative example.

FIG. 3C shows an enlarged detail view of area 3C of FIG. 3B, according to a representative example.

FIG. 4 shows a core for a paddle having multiple core portions, according to a representative example.

FIG. 5 shows a pickleball paddle, according to a representative example.

FIG. 6 shows an exploded view of the pickleball paddle of FIG. 5, according to a representative example.

FIG. 7 shows a pickleball paddle, according to a representative example.

FIG. 8A shows a view of a portion of the pickleball paddle of FIG. 7, according to a representative example.

FIG. 8B shows a view of another portion of the pickleball paddle of FIG. 7, according to a representative example.

FIG. 9A shows a plan view of the pickleball paddle of FIG. 7, according to a representative example.

FIG. 9B shows a cross-sectional view along the line 9B-9B of FIG. 9A, according to a representative example.

FIG. 9C shows an enlarged detail view of area 9C of FIG. 9B, according to a representative example.

FIG. 10 shows a pickleball paddle, according to a representative example.

FIG. 11 shows the pickleball paddle of FIG. 10 without an edge guard, according to a representative example.

FIG. 12 shows an enlarged detail side view of area 12 of the pickleball paddle of FIG. 11, according to a representative example.

FIG. 13A shows a plan view of the pickleball paddle of FIG. 10, according to a representative example.

FIG. 13B shows a cross-sectional view along the line 13B-13B of FIG. 13A, according to a representative example.

FIG. 13C shows an enlarged detail view of area 13C of FIG. 13B, according to a representative example.

FIG. 14 shows a flow chart of a method for forming a pickleball paddle, according to a representative example.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

In general, the devices, systems, kits, and methods disclosed herein relate to paddles such as pickleball paddles. However, it will be understood that, while this disclosure may emphasize the present teachings in the context of pickleball, the present teachings may be adapted and practiced in other sports and activities, including without limitation one or more of: tennis, badminton, squash, racquetball, table tennis (ping pong), padel, and the like. Thus, it shall be understood that, unless expressly stated to the contrary, or otherwise clear from the context, the present teachings are intended to include comparable equipment in other sports/activities in addition to, or instead of, pickleball.

The present teachings may thus relate to paddles (e.g., pickleball paddles) with a mid-layer structure disposed between core portions and/or other portions of the paddle. More specifically, the paddles, systems, methods, and kits disclosed herein may relate to the construction of pickleball paddles with a frame, first and second core portions on opposite sides of the paddle, and a mid-layer disposed between the core portions, where the mid-layer has different properties than the core portions. This construction may allow for customization of the paddle, e.g., customization of its performance characteristics by varying the properties of the mid-layer relative to the core portions, and/or customization of its performance characteristics by varying components engaged with the mid-layer. In this manner, the present teachings may also or instead include removable and replaceable core portions, linking members (e.g., disposed in gaps between core portions and a frame), and playing surfaces that can be coupled to the core portions or other structures of the paddle. In this manner, the paddle structure provides a means for adjusting the paddle’s stiffness, weight distribution, and overall feel, as well as enabling easy replacement or modification of individual components to extend the paddle’s lifespan or adapt its properties for different playing styles or conditions. As explained herein, this can be useful for, inter alia, optimizing paddle performance, customizing paddle characteristics for individual players, and improving the longevity and versatility of pickleball paddles.

Thus, in aspects of the present teachings, a paddle may include a mid-layer structure—optionally attached to the frame, and optionally filling an entirety of the inner area of at least the head portion of the paddle. In such a paddle structure, top and bottom core portions with playing surfaces disposed thereon (e.g., coupled thereto or integral therewith) may be engaged with the mid-layer. That is, in some examples, the core can be the structure that includes the playing surface, e.g., where the core and/or playing surface includes a polymeric foam, which can be achieved because of the inclusion of the mid-layer that provides needed strength and stability in such configurations. More specifically, because of the inclusion of the mid-layer, which may include a relatively high stiffness and is a component disposed within an internal structure of the head portion of a paddle, less stiff and/or lighter core materials may be advantageously utilized. The paddle may further include a gap in which a linking member may be disposed, e.g., placed within the gap between core portions (and/or playing surfaces) and the frame. As described herein, this mid-layer could be a continuous layer, but can also or instead contain voids, such as being a perforated structure, a mesh/grid structure, or similar. By way of example, the mid-layer structure may include one or more of: a carbon fiber layer bonded with the frame, a rubber layer, a plastic layer, strings with tension, and so forth.

It will be understood that the term “paddle” or “pickleball paddle” as used herein shall generally refer to a hand-held implement used to strike a ball in the sport of pickleball or similar, typically comprising a handle portion and a head portion with one or more playing surfaces for contacting the ball. It will further be understood that, as stated above, where the term “pickleball paddle” is used, other paddles are also or instead possible unless expressly stated to the contrary or otherwise clear from the context.

It will be understood that the term “head portion” as used herein shall generally refer to the wider, upper section of a paddle that includes the main playing surface(s) used for striking a ball during gameplay. And it will be understood that the term “handle portion” as used herein shall generally refer to the narrower, lower section of a paddle that is gripped by a player during gameplay, typically extending from the head portion and providing a means for controlling and maneuvering the paddle.

It will be understood that the term “core” or “core portion” as used herein shall generally refer to a structural component of the paddle that forms part of the striking surface (and/or has a striking surface engaged therewith) and/or is part of the internal structure of the paddle. A paddle may include multiple core portions, such as a first core portion on the front side and a second core portion on the back side, which may be at least partially bounded by a frame. The core or core portions may include materials such as polypropylene, foam, aluminum, Nomex, Kevlar, and/or any other synthetic or natural material. The core may include a solid core structure and/or a honeycomb structure and/or an open-cell structure and/or a lattice structure.

It will be understood that the term “frame” as used herein shall generally refer to a structural component of a paddle that provides a desired shape and/or rigidity for the paddle. The frame may surround at least a portion of the perimeter of a paddle, and may be present in one or both of a head portion or handle portion of a paddle.

It will be understood that the term “filler” as used herein shall generally refer to a material used to occupy space within the paddle structure, such as within the frame and/or between other components, which may provide additional structural support, weight distribution, or other functional properties to the paddle.

It will be understood that the term “edge guard” as used herein shall generally refer to a protective component applied to the outer perimeter of a pickleball paddle, typically covering at least a portion of the frame to provide durability and impact resistance.

It will be understood that the term “mid-layer” as used herein shall generally refer to a structural component disposed between core portions of the paddle. The mid-layer may have one or more different properties than the core portions, such as different materials, rigidity, and/or elasticity, and may extend from the frame or be bounded by the frame, directly or indirectly.

It will be understood that the term “playing surface” as used herein shall generally refer to the exterior surface of the paddle that is structurally configured to contact a ball or other projectile during play. The playing surface may be defined by one or more of the core portions or may be a separate component coupled to the core portions.

It will be understood that the term “engagement surface” as used herein shall generally refer to a surface of the mid-layer that interfaces with or connects to a core portion or another portion of the paddle. The mid-layer may have a first engagement surface on the front side of the paddle and a second engagement surface on the back side of the paddle.

It will be understood that the term “linking member” as used herein shall generally refer to a component disposed between other structural elements of a paddle (e.g., between the core and the frame) that provides a physical and/or functional separation between those elements, and which may have different material properties (e.g., greater elasticity) than the elements it separates.

It will be understood that the term “elasticity” as used herein shall generally refer to the ability of a material to deform under stress and return to its original shape when the stress is removed, with materials of greater elasticity exhibiting more deformation and recovery than materials of lesser elasticity under the same applied stress.

It will be understood that the term “kit” as used herein shall generally refer to a collection of components that can be assembled to form a complete paddle. A kit may include a paddle structure with a frame and mid-layer, as well as separate core portions and potentially additional components such as playing surfaces and/or linking members.

It will be understood that the term “removable” as used herein shall generally refer to a component that can be detached or separated from another component or structure without destroying or permanently damaging either the component being removed or the structure from which it is removed. It will be understood that the term “replaceable” as used herein shall generally refer to a component that, after being removed, can be substituted with another component of the same or similar type, where the replacement component can be attached or engaged in a manner that restores functionality without requiring permanent alteration to the receiving structure.

It will be understood that any of the devices, systems, apparatus, methods, kits, and so forth as described herein may include one or more features as described in Int’l Pat. App. No. PCT/US2024/042535 filed on August 15, 2024 (and published as WO2025/049122), the entire contents of which is hereby incorporated by reference.

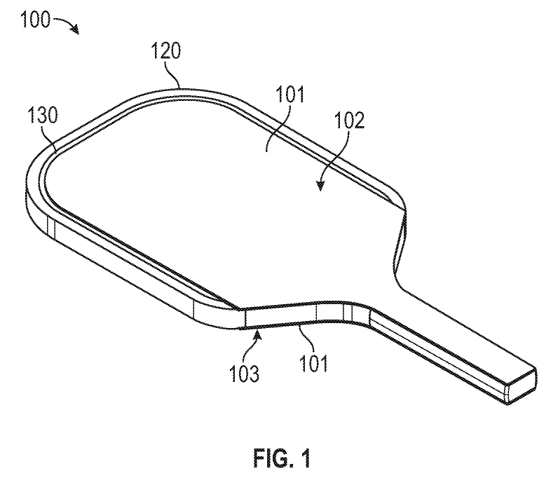

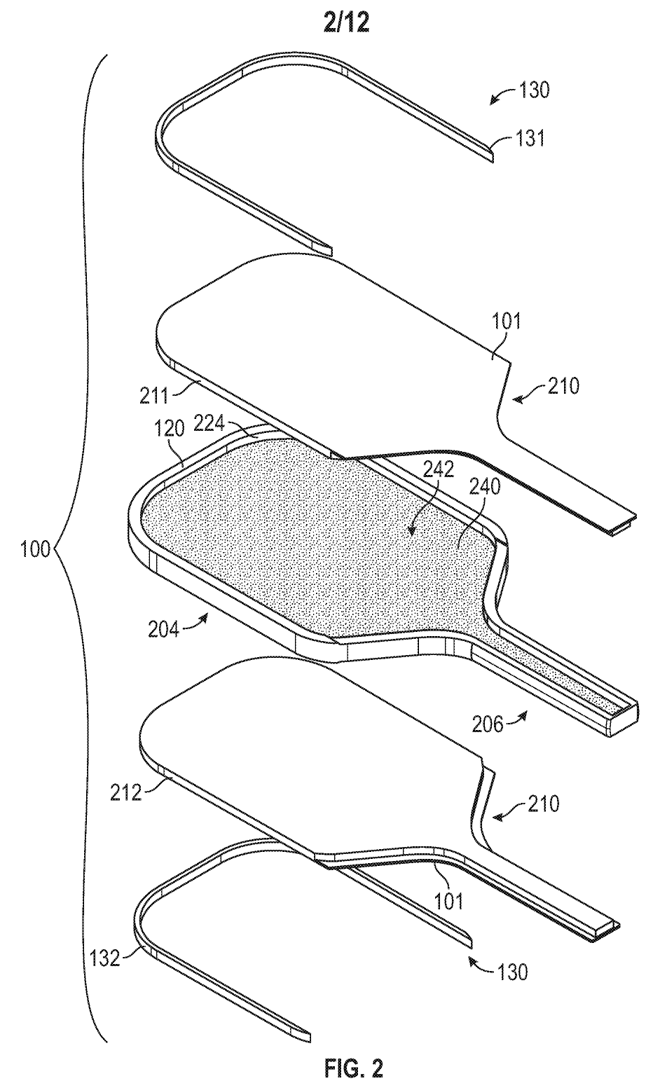

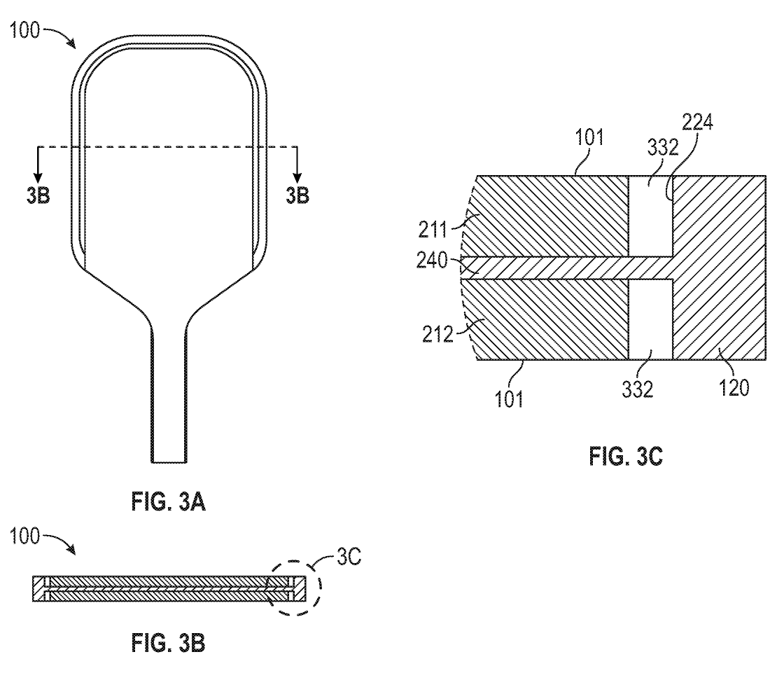

FIG. 1 shows a pickleball paddle 100, FIG. 2 shows an exploded view of the paddle 100 of FIG. 1, and FIGS. 3A-3C show, respectively, a plan view, a cross-sectional view, and an enlarged detail view of the paddle 100 of FIG. 1, according to representative examples. The paddle 100 may be a pickleball paddle, and it may include a mid-layer 240 as described herein.

As shown in FIG. 1, the paddle 100 may include an exterior surface 101 that extends across both a front side 102 and a back side 103, a frame 120 that extends around at least a portion of the perimeter of the paddle 100 to provide structural support and to define the paddle’s overall shape, and a linking member 130 creating a connection between the frame 120 and the exterior surface 101 and/or one or more core portions or internal structures, fillers, or the like. The paddle 100 has an elongated shape with a wider head portion that tapers into a narrower handle portion, facilitating grip and control during play. The exterior surface 101 may form the playing surface of the paddle 100 for striking a ball, while the frame 120 and linking member 130 may provide structural integrity and specific performance characteristics for the paddle 100. It shall be understood that, in some aspects, the frame 120 may be omitted, e.g., at least about a portion of the perimeter of the paddle 100.

The exterior surface 101 of the paddle 100 may extend across either or both the front side 102 and the back side 103, providing a continuous playing surface for striking a ball. In certain aspects, the exterior surface 101 may be integrally formed with a core portion of the paddle 100. Alternatively, the exterior surface 101 may be a separate component that is coupled to one or more core portions, a frame, or another portion of the paddle 100. The exterior surface 101 may, in some aspects, extend onto the handle portion of the paddle 100, e.g., where it can be wrapped or otherwise enveloped by a grip, tape, or the like. The exterior surface 101 may be bounded by the frame 120, which may extend around the perimeter of the paddle 100. In some implementations, the exterior surface 101 may directly contact the frame 120. In addition, or instead, the linking member 130 or another structure (e.g., a filler or the like) may be disposed between the exterior surface 101 and the frame 120, providing a transition between these components. The exterior surface 101 may have various textures or finishes to affect the paddle’s interaction with a ball during play. For example, the exterior surface 101 may have a smooth finish, a textured finish, or a combination thereof. The texture or finish of the exterior surface 101 may be uniform across both the front side 102 and the back side 103, or may vary between these sides or across different regions of the paddle 100. In certain aspects, the exterior surface 101 may be constructed from materials selected to provide specific performance characteristics, such as durability, ball control, or power transfer. These materials may include, but are not limited to, composites, polymers, or metals. The material composition of the exterior surface 101 may be uniform throughout, or may vary across different regions of the paddle 100 to optimize performance in specific areas.

The frame 120 may extend around the perimeter of the paddle 100, providing structural support and defining the overall shape of the paddle 100. In certain aspects, the frame 120 may bound the entire perimeter of the paddle 100, enclosing both the head portion and the handle portion. Alternatively, the frame 120 may bound only a portion of the perimeter of the paddle 100, or none at all. The frame 120 may be constructed as a single continuous piece or may comprise multiple sections. The frame 120 may have various cross-sectional profiles, such as having different shapes and/or sizes, and/or the frame 120 may be hollow (e.g., where the frame 120 is partially or wholly filled with a filler), solid, or a combination thereof. The frame 120 may be constructed from various materials, including but not limited to metals, composites, or polymers. The choice of material for the frame 120 may affect the overall weight, balance, flex, stiffness, and/or performance characteristics of the paddle 100. In certain aspects, the frame 120 may include features for attaching additional components, such as a grip on the handle portion or an edge guard around the perimeter of the paddle 100. These features may include grooves, channels, and/or engagement points integrated into the structure of the frame 120.

The linking member 130 may be disposed between the frame 120 and other structures of the paddle 100, such as the exterior surface 101 of the paddle 100 in one or more regions of the paddle 100. In certain aspects, the linking member 130 may extend along an interior perimeter 224 of the frame 120, creating a connection between the frame 120 and the exterior surface 101. The linking member 130 may serve to provide a transition between the frame 120 and the exterior surface 101. In some aspects, the linking member 130 may completely surround the core of the paddle 100. In this configuration, the linking member 130 may form a continuous interface between the frame 120 and one or more interior components of the paddle 100, such as the core. This arrangement may help distribute forces more evenly throughout the paddle 100 during play, potentially improving the paddle’s performance and durability. The linking member 130 may be constructed from materials selected to provide specific performance characteristics. For example, the linking member 130 may be made from materials with different properties than the frame 120 or the exterior surface 101, allowing for customization of the paddle’s flex, vibration dampening, and/or energy transfer characteristics. In certain aspects, the linking member 130 includes a greater elasticity than one or more of the core, the frame 120, and the exterior surface 101. In certain aspects, the linking member 130 may have a variable thickness or composition along its length. This variation may allow for different performance characteristics in different areas of the paddle 100, such as increased stiffness in the head portion or enhanced flexibility in the handle portion. The linking member 130 may be bonded to both the frame 120 and the exterior surface 101 using various methods, such as adhesive bonding, mechanical fastening, or co-molding during the manufacturing process. In another aspect, the paddle 100 may not include a linking member; instead the region where the linking member is illustrated in some figures may include one or more of a core, a filler, a first or second surface, or a gap.

The linking member 130 may be formed from a variety of materials selected to provide desired performance characteristics for the paddle 100. In some aspects, the linking member 130 may comprise polymeric materials such as rubber, silicone, thermoplastic elastomers, or polyurethane. The linking member 130 may also or instead include foam materials, such as ethylene-vinyl acetate (EVA) foam, polyethylene foam, or other closed-cell or open-cell foam structures. In certain aspects, the linking member 130 may comprise composite materials that combine multiple material types to achieve specific mechanical properties. The linking member 130 may be formed from materials that are the same as or different from the materials used for the frame 120, the core portions, or the exterior surface 101.

In alternative configurations, the linking member 130 may be implemented as a continuous strip, a segmented structure, or a series of discrete elements positioned at intervals around the interior perimeter of the frame 120. The linking member 130 may have a uniform cross-sectional profile along its length, or the cross-sectional profile may vary to provide different performance characteristics in different regions of the paddle 100. In some aspects, the linking member 130 may include one or more channels, grooves, or apertures that affect its flexibility or weight distribution. The linking member 130 may be a single-piece component or may comprise multiple layers of the same or different materials. In certain aspects, the linking member 130 may include attachment features such as adhesive surfaces, interlocking profiles, or mechanical engagement elements to facilitate connection with the frame 120, the core portions, or other components of the paddle 100.

The material properties of the linking member 130 may be selected based on desired paddle performance characteristics. For instance, the linking member 130 may exhibit a hardness in a range suitable for providing vibration dampening while maintaining structural integrity during ball strikes. The linking member 130 may have a flexibility sufficient to accommodate deformation during play while returning to its original shape after stress is removed. In some aspects, the linking member 130 may provide thermal stability across a range of temperatures encountered during outdoor or indoor play. The linking member 130 may also or instead exhibit durability characteristics that allow it to withstand repeated impacts without degradation over extended periods of use. It shall be understood that, in certain aspects, the linking member is completely absent.

As demonstrated by FIG. 2, the paddle 100 may be part of a kit that allows for customization and assembly of various components, or otherwise part of a system for playing a paddle sport. The exploded view shows an example of a layered construction of the paddle 100, including a head portion 204 and a handle portion 206. The paddle 100 may include: the frame 120, which forms the outer structure of the paddle 100 in this example; one or more linking members 130 for positioning adjacent to the frame 120 (e.g., along an interior perimeter 224 of the frame); and a core 210 with a first core portion 211 and a second core portion 212, which may form or otherwise be engaged with the exterior surface 101 on the front side 102 and back side 103, respectively. A mid-layer 240 may be included, where such a mid-layer 240 may be disposed between the first core portion 211 and the second core portion 212, and where the mid-layer 240 may have different properties than the first core portion 211 and the second core portion 212.

It will be understood that the view of the frame 120 and mid-layer 240 in FIG. 2 shows one side of the paddle 100 (e.g., the front side 102), where the opposite side of the paddle 100 (e.g., the back side 103) may include a similar appearance (e.g., the opposite side may look exactly the same, being a mirror image of the side shown in FIG. 2). Thus, in this manner, the core 210 may include portions that are engageable with the mid-layer 240 on respective sides of the paddle 100. That is, the core 210 may include a first core portion 211 on a front side 102 of the paddle 100, and a second core portion 212 on a back side 103 of the paddle 100, disposed opposite the front side 102. In a similar manner, the paddle 100 may include a linking member 130 disposed on each side of the paddle 100—a first linking member 131 disposed on the front side 102 of the paddle 100, and a second linking member 132 disposed on the back side 103 of the paddle 100.

Therefore, the core 210 of the paddle 100 may include the first core portion 211 and the second core portion 212. In certain aspects, the first core portion 211 and the second core portion 212 may be discrete components, with the first core portion 211 positioned on the front side 102 of the paddle 100 and the second core portion 212 positioned on the back side 103 of the paddle 100. In certain aspects, the first core portion 211 and the second core portion 212 may form the exterior surface 101 on their respective sides of the paddle 100. Alternatively, the first core portion 211 and the second core portion 212 may each be covered by a separate exterior surface 101 component. This configuration may allow for independent customization or replacement of each core portion and/or each playing surface.

The first core portion 211 and the second core portion 212 may be configured to fit within the frame 120 of the paddle 100, e.g., where they can be seated on or otherwise engaged with or coupled to the mid-layer 240. The frame 120 may thus define a cavity 242 or recess on each of the front side 102 and the back side 103 of the paddle 100, into which the first core portion 211 and the second core portion 212 may be respectively inserted. The mid-layer 240 may be designed to accommodate these core portions, potentially providing a surface or structure against which the first core portion 211 and the second core portion 212 may be seated. One or more of the first core portion 211 and the second core portion 212 may be at least partially bounded by the frame 120—where being “bounded by” in this context shall include the frame 120 at least partially surrounding a core portion by being directly adjacent to it, and/or the frame 120 at least partially surrounding a core portion with one or more components or interstitial spacing therebetween (e.g., a linking member 130, a gap, or the like), which thus includes indirectly bounding the core portion with the frame 120. In some aspects, one or more of the first core portion 211 and the second core portion 212 may extend from the head portion 204 of the paddle 100 to the handle portion 206 of the paddle 100.

The first core portion 211 and the second core portion 212 may be removably and replaceably coupled with the mid-layer 240. This configuration may allow for easy replacement or modification of the core portions without necessitating replacement of the entire paddle 100. The coupling between the core portions and the mid-layer 240 may be achieved through various means, such as mechanical fasteners, adhesives, or interlocking designs that facilitate secure attachment while allowing for future removal. By way of example, coupling the core portions to the mid-layer 240 may include the use of mechanical means such as one or more of the following : hook and loop fasteners, buttons, snaps, sliders, friction fits, snap-fits, magnetic attraction (e.g., magnetic elements may be coupled to and/or incorporated into the core portions and/or the mid-layer 240 to create a removable magnetic attachment), screws, bolts, pins, interlocking components, clips, latches, and the like.

The removable and replaceable nature of the first core portion 211 and the second core portion 212 may provide several advantages. For example, worn or damaged core portions may be replaced to extend the lifespan of the paddle 100. Also or instead, players may swap out core portions with different properties to customize the paddle 100 for specific playing conditions or personal preferences. This modularity may enhance the versatility and longevity of the paddle 100.

The mid-layer 240 may be disposed between the first core portion 211 and the second core portion 212, potentially providing additional structural support or performance characteristics for the paddle 100. In certain aspects, the mid-layer 240 may be made from one or more of the same materials as the frame 120, or it may be made from different materials. The mid-layer 240 may be bonded to the frame 120 using various methods, such as adhesive bonding, mechanical fastening, or co-molding during a manufacturing process. This bonding may ensure a secure connection between the mid-layer 240 and the frame 120. In certain aspects, the mid-layer 240 may be an extension of the frame 120. Stated otherwise, the mid-layer 240 may extend from the frame 120, or may be unitarily formed therewith. This extension may create a continuous structure from the frame 120 to the interior of the paddle 100, potentially enhancing the transfer of energy during play, e.g., to reduce vibrations during play, and/or for sound dampening or similar. By way of example, the frame 120 may bound an entire perimeter of the paddle 100, where the mid-layer 240 is present within an entirety of an area bounded by the frame 120. For example, in this or other aspects, the mid-layer 240 may be a continuous sheet or strip of material. Alternatively, the mid-layer 240 may include one or more voids, which may be design features determined to provide a specific weight, stiffness, or other performance property of the paddle. For example, the mid-layer 240 may include a mesh material.

Also or instead, the mid-layer 240 may include material disposed in a pattern defining one or more voids (e.g., apertures, indentations, internal voids, and the like). The mid-layer 240 may include voids arranged in various patterns that influence paddle performance in different ways. In some aspects, the mid-layer 240 may include a honeycomb pattern of hexagonal voids, which may provide a balance of structural support and weight reduction while distributing impact forces across the playing surface. In other aspects, the mid-layer 240 may include a radial pattern of voids emanating from a central point of the head portion 204, which may influence how energy transfers from the point of ball contact toward the perimeter of the paddle 100. The mid-layer 240 may also or instead include a grid pattern of polygonal voids (e.g., rectangular or square voids), which may provide uniform flexibility characteristics across the playing surface and may allow for consistent response regardless of where the ball strikes the paddle 100. In some cases, the mid-layer 240 may include a concentric pattern of voids arranged, e.g., in rings, which may create zones of varying stiffness from the center of the paddle 100 toward its edges, potentially providing a larger effective sweet spot. In certain aspects, the mid-layer 240 may include an asymmetric or irregular pattern of voids, which may be configured to shift the weight distribution of the paddle 100 or to provide different response characteristics in different regions of the playing surface.

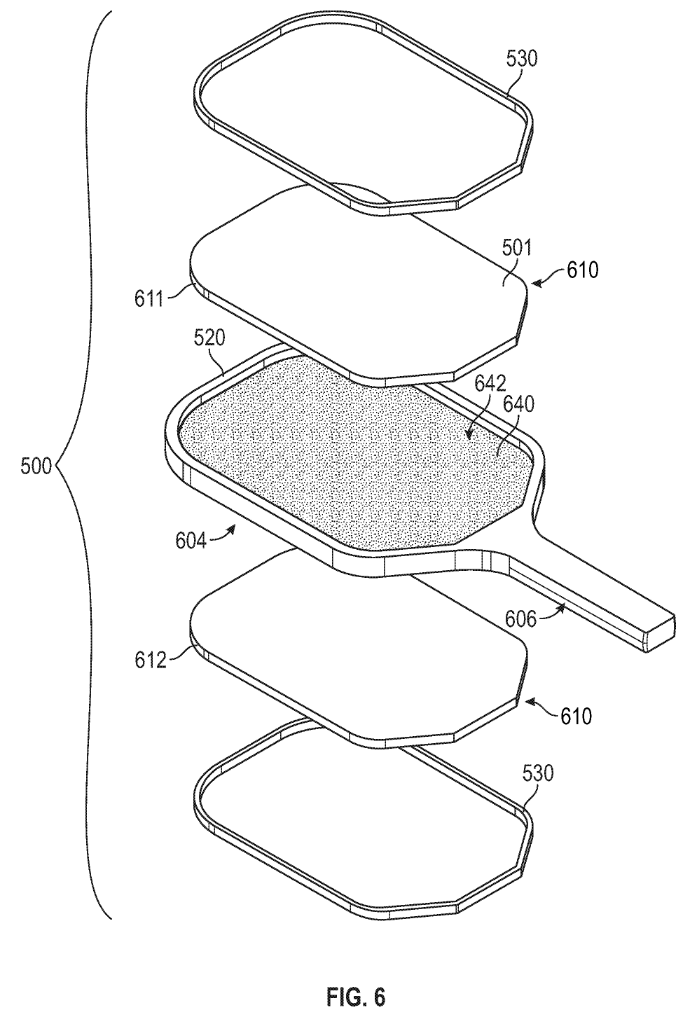

The mid-layer 240 may be present within the entirety of the area bounded by the frame 120, where this configuration may provide consistent support and performance characteristics across the entire playing surface of the paddle 100. In some aspects, the mid-layer 240 may extend from the head portion 204 through the handle portion 206, ensuring uniform structural properties throughout the paddle 100. Thus, by way of example, the mid-layer 240 may be present within the head portion 204 of the paddle 100 (e.g., where the mid-layer 240 is present within an entirety of the head portion 204 of the paddle 100). In such configurations, the mid-layer 240 may be confined to the head portion 204 of the paddle 100 in an aspect (see, e.g., FIG. 6 described below). Alternatively, the mid-layer 240 may be present within a handle portion 206 of the paddle 100 (e.g., where the mid-layer 240 is present within an entirety of the handle portion 206 of the paddle 100). Thus, the mid-layer 240 may be present within each of a head portion 204 and a handle portion 206 of the paddle 100.

The mid-layer 240 may be made from the same material as another component of the paddle 100—e.g., the frame 120. In some aspects, the mid-layer 240 comprises carbon fiber. The mid-layer 240 may also or instead include at least one of rubber, plastic, a plurality of strings (e.g., a plurality of strings in tension, where such strings may extend from the frame), and the like. The mid-layer 240 may be a substantially continuous (and/or substantially uniform) layer or sheet of material. In other aspects, the mid-layer 240 may be substantially discontinuous (and/or substantially nonuniform). In some aspects, the mid-layer 240 may be porous, and/or may include one or more voids, indentations, or the like. The mid-layer 240 may also or instead include one or more protrusions (e.g., to aid in coupling with core portions).

The mid-layer 240 may have different properties than the first core portion 211 and the second core portion 212. This configuration may allow for customization of paddle performance characteristics, such as weight distribution, stiffness, vibration dampening, sound dampening, or similar. The relationship between the mid-layer 240 and the core portions may significantly influence the overall feel and performance of the paddle 100 during play. The mid-layer 240 may provide a predetermined stiffness for the paddle, and may be sufficiently stiff to permit one or more of the first core portion and the second core portion to be the playing surface for the paddle. That is, in some examples, inclusion of the mid-layer having the predetermined stiffness may enable the core structure to include the playing surface (e.g., the core and playing surface may include a polymeric foam), which can be achieved because the mid-layer provides increased strength and stability to the core in such configurations, as compared to a paddle without such a mid-layer. In addition, or instead, inclusion of a mid-layer having a relatively high stiffness may permit less stiff and/or lighter core materials to be utilized.

It will be understood that the mid-layer 240 structure itself may include features that were previously found in core portions of paddles. By way of example, the mid-layer 240 may itself define an interior that includes core materials (e.g., a honeycomb core, a foam, etc.) and/or fillers. For example, the interior of the mid-layer 240 may include a core material therein that defines one or more gaps (e.g., along a perimeter structure formed by the core material) that are filled, wholly or partially, with a filler. That is, it will be understood that the interior of the mid-layer 240 may include any of the features of the cores described in, e.g., Int’l Pat. App. No. PCT/US2024/042535 filed on August 15, 2024 (and published as WO2025/049122), the entire contents of which is hereby incorporated by reference.

It will also be understood that the mid-layer 240 structure itself may include features of the frames described in, e.g., Int’l Pat App. No. PCT/US2025/023898 filed on April 9, 2025 (and published as WO2025/221545), the entire contents of which is hereby incorporated by reference. That is, the mid-layer 240 may include a region (e.g., a region disposed adjacent to a throat portion of the paddle) that is thinner than other regions of the mid-layer 240. The lack of material in this portion of the mid-layer 240—e.g., disposed directly above the handle—may provide advantageous flexing of the paddle during play (e.g., how fast the paddle can return to the original shape after being flexed), improving power characteristics, control, feel, responsiveness, and/or the like. Moreover, a gap formed by the lack of material in this portion of the mid-layer 240 can provide a region for enhanced weight control (e.g., by filling the gap with a weighted material), and/or for enhanced sound or vibration control (e.g., by filling the gap with a sound dampening and/or vibration dampening material).

FIGS. 3A-3C provide additional details of the construction of the paddle 100, by way of example. As shown in the enlarged cross-sectional view of FIG. 3C, the paddle 100 may include the frame 120 forming an outer boundary, with the first core portion 211 and the second core portion 212 positioned on opposite sides of the mid-layer 240. The exterior surface 101 extends across both the front side 102 and the back side 103 of the paddle 100, where this exterior surface may be integral with the core portions or a separate component (e.g., a removable and replaceable playing surface). A gap 332 may be formed between portions of the paddle structure (e.g., between an interior perimeter 224 of the frame 120 and one or more of the core portions 211, 212). In certain aspects, the linking member 130 and/or a filler may be disposed within at least a portion of the gap 332, providing a connection between various components.

The mid-layer 240 may be an extension of the frame 120 as shown in the figure, or the mid-layer 240 may otherwise be bonded to the frame 120 using various methods. In other aspects, the mid-layer 240 may be disconnected—completely or partially—from the frame 120. In certain aspects and as shown in the figure, the mid-layer 240 may be thinner than the first core portion 211 and the second core portion 212 (where thickness is measured in a direction between the front side 102 and the back side 103). The thickness and profile of the mid-layer 240 may be selected to provide specific performance characteristics. In some aspects, the thickness and profile of the mid-layer 240 may vary along the paddle 100 to provide specific performance characteristics in different areas of the paddle 100.

In certain aspects, the mid-layer 240 may be more rigid than the first core portion 211 and the second core portion 212. This configuration may allow for customization of paddle performance characteristics, such as increased stiffness in the striking area of the paddle 100. Alternatively, in certain aspects, the mid-layer 240 may be more elastic than the first core portion 211 and the second core portion 212, and/or the frame 120. This arrangement may provide different performance characteristics to the paddle 100, such as enhanced flex or improved vibration dampening during ball strikes. The relative elasticity or rigidity of the mid-layer 240 compared to other components of the paddle 100—e.g., one or more of the first core portion 211 and the second core portion 212, the frame 120, the exterior surface 101, etc.—may influence the overall feel and performance of the paddle 100 during play. For example, a more elastic mid-layer 240 may allow for greater deformation of the paddle 100 upon ball impact, potentially increasing power transfer, spin generation, or the like. Conversely, a more rigid mid-layer 240 may provide enhanced control and precision by minimizing paddle deformation during ball strikes. Therefore, in certain aspects, the mid-layer 240 may have different properties than the first core portion 211 and the second core portion 212. This configuration may allow for customization of paddle performance characteristics, such as weight distribution, stiffness, or vibration dampening.

The gap 332 may serve various functions within the paddle structure. In some configurations, the gap 332 may remain empty, creating a void space that may influence the paddle’s weight distribution, acoustic properties, vibration dampening, and so forth. Alternatively, the gap 332 may be filled with one or more materials to achieve specific performance characteristics. In certain aspects, a filler may be disposed within the gap 332. This filler may be selected from a range of materials with properties that complement or enhance the overall performance of the paddle 100. For example, the filler may be a lightweight foam to maintain a low overall weight while providing structural support, or it may be a denser material to add weight to specific areas of the paddle 100 for balance or power enhancement. The gap 332 may also or instead be utilized to accommodate the linking member 130. In such configurations, the linking member 130 may be disposed within at least a portion of the gap 332, providing a connection between various components of the paddle 100. The linking member 130 may serve as an interface between the frame 120 and other internal components, such as the first core portion 211 and the second core portion 212. In certain aspects, the gap 332 may extend through each of the first core portion 211 and the second core portion 212, wholly or partially. For example, the gap 332 may include a continuous void or filled space that runs through at least a majority of the thickness of the paddle 100. When the gap 332 extends through both core portions, it may allow for the insertion of materials or components that span the entire thickness of the paddle 100, providing opportunities for further customization of paddle properties. The presence and configuration of the gap 332 may significantly influence the overall performance and feel of the paddle 100 during play. By varying the size, shape, and contents of the gap 332, manufacturers may be able to fine-tune the paddle’s characteristics to suit different playing styles or preferences.

Therefore, the gap 332 may be formed between at least one of: (i) the first core portion 211 and the frame 120, and (ii) the second core portion 212 and the frame 120. And the paddle 100 may further include a linking member 130 disposed within at least a portion of the gap 332. The gap 332 may be formed along each of the front side 102 and the back side 103 of the paddle 100, e.g., where a first linking member 131 is disposed in the gap 332 on the front side 102 of the paddle 100, and where a second linking member 132 is disposed in the gap 332 on the back side 103 of the paddle 100. In aspects, the first linking member 131 and the second linking member 132 are substantially the same. In other aspects, the first linking member 131 and the second linking member 132 are different. Also or instead, a filler may be disposed within at least a portion of the gap 332. In alternative aspects, the gap may be omitted.

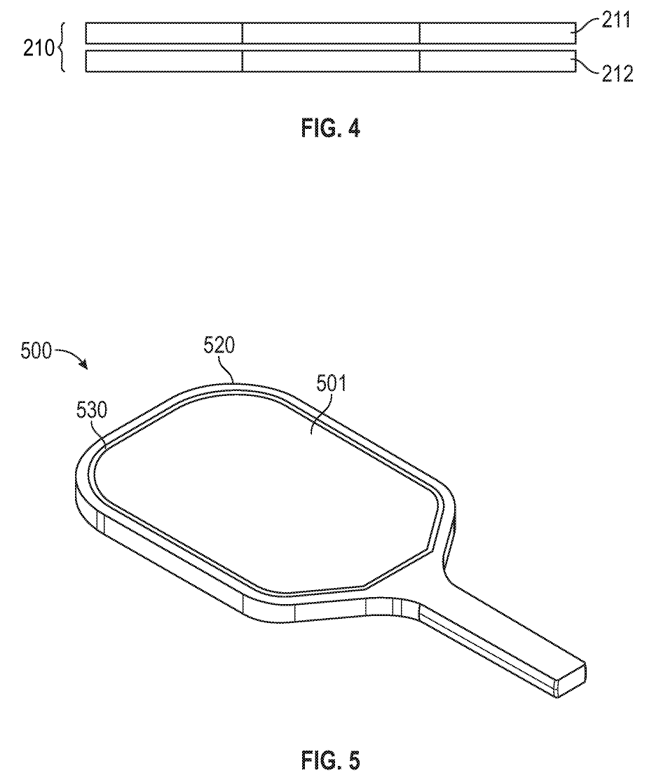

FIG. 4 shows a core 210 for a paddle having multiple core portions, according to a representative example. It will be understood that the core 210 and its core portions may be included on any of the paddles described herein. In general, the core 210 may be a component of the paddle that forms part of the striking surface and/or internal structure. The core 210 may include a first core portion 211 and a second core portion 212—which may be the same or similar to those described above or elsewhere herein—where these portions may be arranged in a parallel configuration when assembled on a paddle (e.g., arranged on opposing sides of a mid-layer such as the mid-layer 240 of FIG. 2). Each core portion may have the same or similar cross-sectional profile, and may be of similar thickness; or the core portions may be different (e.g., including different sizes, shapes, materials, core structure, and the like). The first core portion 211 and second core portion 212 are shown separated by a small gap between them, illustrating the distinct and separate nature of these components, which may be so separated on a paddle via a mid-layer or other structure/component.

In certain aspects, the first core portion 211 and the second core portion 212 may be removable and replaceable components of the paddle. This configuration may allow for customization of the paddle’s performance characteristics and/or replacement of worn components. For example, the first core portion 211 and the second core portion 212 may be included as separate components in a kit for assembling or modifying the paddle. As such, either or both of the first core portion 211 and the second core portion 212 may include one or more features structurally configured to promote or accommodate removal of the core portion from the paddle (e.g., in a non-destructive fashion) and/or placement or replacement of the core portion within the paddle. Examples of such features include: an adhesive or glue, tape, a hook and loop fastener, elements configured for snap-fit connection or friction-fit connection, one or more magnets (e.g., coupled to components, embedded within components, or defining a material of the components), a clamp, a clip, a dowel, a mechanical keying element, a feature configured to interlock with other paddle elements, a latch, a nail, a pin, a rivet, a screw, a slider, a spike, and the like.

FIG. 5 shows a pickleball paddle 500, and FIG. 6 shows an exploded view of the paddle 500 of FIG. 5, according to a representative example. The paddle 500 may include any of the features described herein with reference to other paddles, and vice-versa. The paddle 500 may include an exterior surface 501 that forms the playing surface of the paddle, a frame 520 extending around at least a portion of the perimeter of the paddle 500 and providing structural support, and a linking member 530 disposed between the frame 520 and exterior surface 501 as shown. The linking member 530 may extend continuously around the interior perimeter of the frame 520 creating a connection between the frame 520 and the exterior surface 501 and/or other components such as a core portion. Unlike other paddles described herein, the paddle 500 may feature a linking member 530 that completely surrounds the core providing a continuous interface between the frame 520 and the interior components. The paddle 500 may further include a frame 520 that is disposed in the head portion of the paddle 500 forming a seating area for other components in the head portion, such as the linking member 530, the exterior surface 501, a mid-layer, and/or one or more core portions.

As shown in FIG. 6, the paddle 500 may comprise a core 610 that includes a first core portion 611 and a second core portion 612. These core portions may be positioned to be assembled within the paddle structure—e.g., seated within the frame 520 along a mid-layer 640, such as where each side of the paddle 500 contains its own core portion disposed on the mid-layer 640. Thus, in certain aspects, the first core portion 611 and the second core portion 612 may be discrete components, with the first core portion 611 positioned on the front side of the paddle 500 and the second core portion 612 positioned on the back side of the paddle 500. This configuration may allow for independent customization or replacement of each core portion.

The first core portion 611 and the second core portion 612 may be configured to fit within the frame 520 of the paddle 500. The frame 520 may define cavities 642 or recesses on both the front side and the back side of the paddle 500, into which the first core portion 611 and the second core portion 612 may be respectively inserted. The mid-layer 640 may be designed to accommodate these core portions, potentially providing a surface or structure against which the first core portion 611 and the second core portion 612 may be positioned. The first core portion 611 and the second core portion 612 may be removably and replaceably coupled with the mid-layer 640. This configuration may allow for easy replacement or modification of the core portions without necessitating replacement of the entire paddle 500. The coupling between the core portions and the mid-layer 640 may be achieved through various means, such as mechanical fasteners, adhesives, tape, and/or interlocking designs that facilitate secure attachment while allowing for future removal (e.g., non-destructive removal) and potentially reengagement.

The paddle 500 may generally include a head portion 604 and a handle portion 606. The mid-layer 640 may be present within the head portion 604 of the paddle 500. In certain aspects, the mid-layer 640 may be confined to the head portion 604 of the paddle 500. This configuration differs from the paddle 100 shown in FIG. 2, for example, where the mid-layer 240 extends through both the head portion and the handle portion of the paddle 100. By confining the mid-layer 640 to the head portion 604, the paddle 500 may be more accommodating for assembly and/or reassembly.

The linking member 530 shown in the exploded view of FIG. 6 may be configured as a single component or as multiple discrete components. In certain aspects, the linking member 530 may comprise two separate components, with one component positioned on the front side of the paddle 500 and another component positioned on the back side of the paddle 500. This configuration may allow for customization of the linking member 530 properties on each side of the paddle 500. In some aspects, the linking member 530 may define one continuous, closed shape—e.g., where the linking member 530 is structurally configured to fully surround a core portion of the paddle 500. In another aspect, the linking member 530 may include multiple components on each side of the paddle 500, where the components may or may not be configured to completely surround the respective core portion. In another aspect, the paddle may not include a linking member.

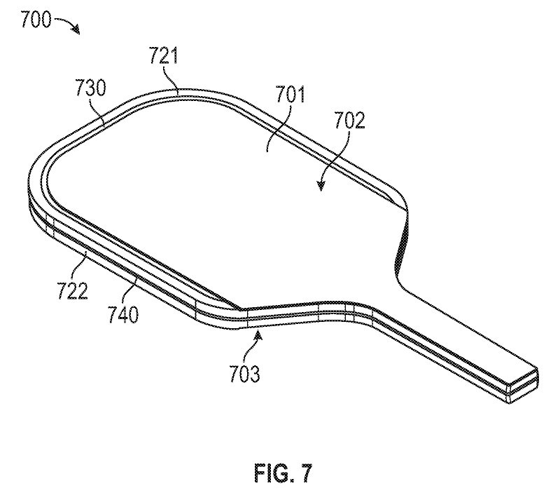

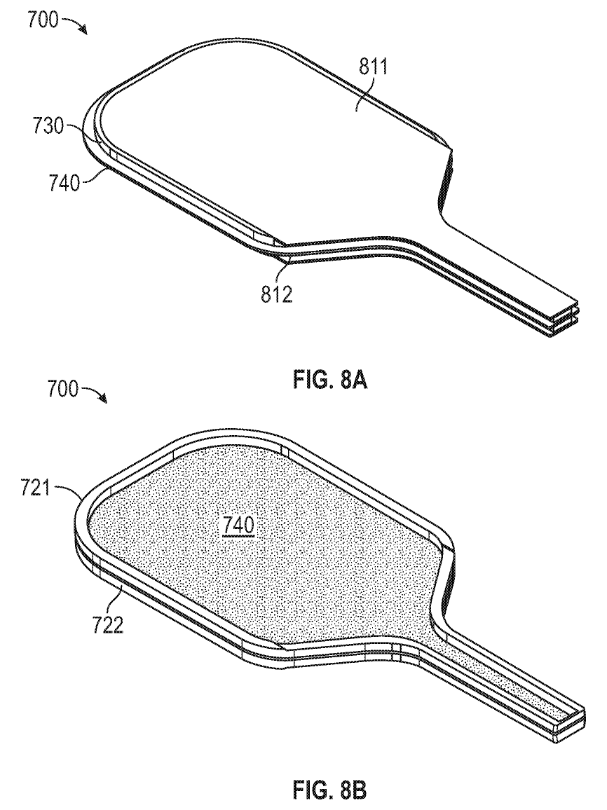

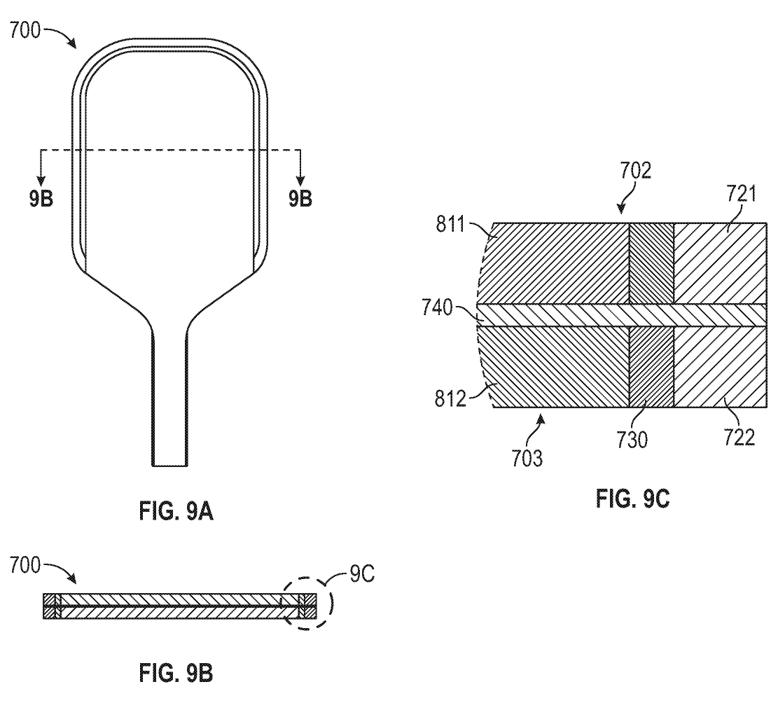

FIG. 7 shows a pickleball paddle 700, FIGS. 8A and 8B shows views of portions of the paddle 700 of FIG. 7, and FIGS. 9A-9C, respectively, show a plan view, a cross-sectional view, and an enlarged detail view of the paddle 700 of FIG. 7, according to representative examples. The paddle 700 may include any of the features described herein with reference to other paddles, and vice-versa. Similar to other paddles described herein, the paddle 700 may include an exterior surface 701 (e.g., a playing surface for the paddle 700) disposed on both a front side 702 and a back side 703 of the paddle 700, a linking member 730 (which may be the same or similar to any as described herein), and a mid-layer 740. The frame of the paddle 700, however, may include a plurality of portions—e.g., a first frame portion 721 and a second frame portion 722. The mid-layer 740 may extend within the interior region bounded by the first frame portion 721 and second frame portion 722.

FIG. 8A shows a portion of the paddle 700 where the mid-layer 740 is positioned between a first core portion 811 and a second core portion 812 with the linking member 730 coupled thereabout; and FIG. 8B shows a portion of the paddle 700 where the mid-layer 740 is shown disposed between each of the first frame portion 721 and second frame portion 722 for clarity (note that while the mid-layer 740 is shown in each of the two views, the assembled paddle 700 may include only a single mid-layer 740). The first frame portion 721 and the second frame portion 722 may include any features of frames for paddles as described herein, e.g., having various cross-sectional profiles (such as hollow, solid, or filled with a filler material), have consistent or varying thicknesses and shapes, be constructed from one or more of a variety of materials, and so forth. The views in FIGS. 8A–8B demonstrate one example of how the mid-layer 740 may be integrated into the overall structure of the paddle 700—e.g., the mid-layer 740 may be sandwiched between the first frame portion 721 and the second frame portion 722, with the linking member 730 positioned around the interior perimeter of the frame. The mid-layer 740 may extend to the outer perimeter of the frame.

FIG. 9A shows a plan view of the pickleball paddle of FIG. 7, according to a representative example; FIG. 9B shows a cross-sectional view along the line 9B-9B of FIG. 9A; and FIG. 9C shows an enlarged detail view of area 9C of FIG. 9B including the first frame portion 721 and the second frame portion 722, the linking members 730, and the first core portion 811 and a second core portion 812 positioned on opposite sides of the mid-layer 740. Thus, the cross-sectional view in FIG. 9C illustrates an example of the arrangement of the first core portion 811, the second core portion 812, and the mid-layer 740 within the paddle 700. The first core portion 811 may be positioned on the front side 702 of the paddle 700, while the second core portion 812 may be positioned on the back side 703. The mid-layer 740 may be disposed between the first core portion 811 and the second core portion 812, creating a sandwich-like structure within the paddle 700. In addition, the mid-layer 740 may be disposed between the first frame portion 721 and the second frame portion 722, and may extend to an outer perimeter of the paddle 700.

In certain aspects, the mid-layer 740 may have different properties than the first core portion 811 and the second core portion 812. For example, the mid-layer 740 may be constructed from materials with different stiffness, density, and/or elasticity compared to the core portions. This configuration may allow for customization of the paddle’s flex, vibration dampening, and/or energy transfer characteristics.

The thickness of the first core portion 811, the second core portion 812, and the mid-layer 740 may vary within each element, or among multiple elements. In certain aspects, the mid-layer 740 may be thinner than each of the first core portion 811 and the second core portion 812. Alternatively, the mid-layer 740 may be thicker than the core portions, depending on the desired performance characteristics of the paddle 700.

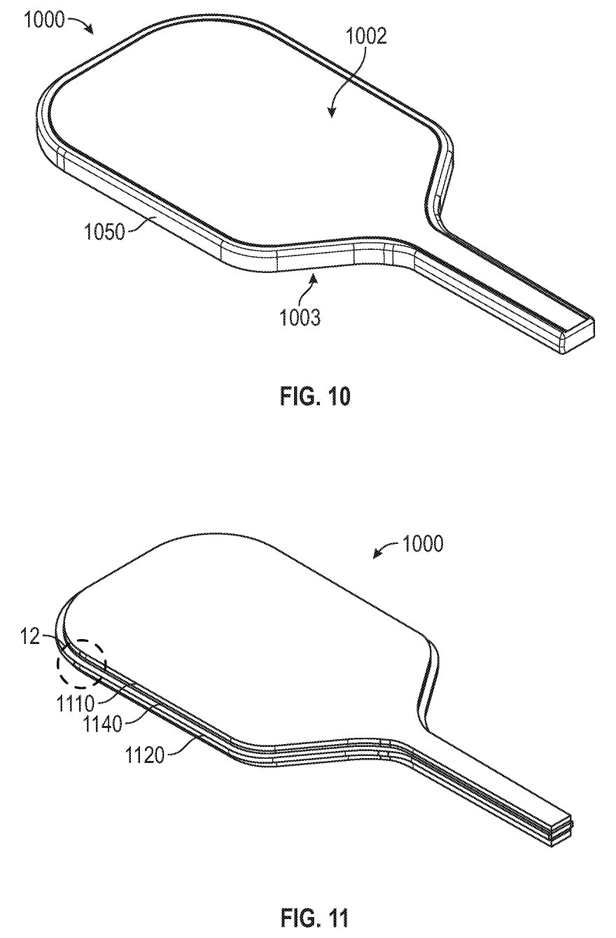

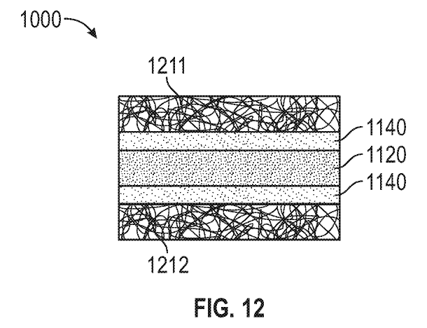

FIG. 10 shows a pickleball paddle 1000, FIG. 11 shows the paddle 1000 of FIG. 10 without an edge guard 1050, FIG. 12 shows an enlarged detail side view of area 12 of the pickleball paddle 1000 of FIG. 11, according to representative examples. The paddle 1000 may include any of the features described herein with reference to other paddles, and vice-versa. However, in this example embodiment, the paddle 1000 may include a frame 1120 that is thinner than the mid-layer 1140 (e.g., where thickness is measured in a direction between front side 1002 and back side 1003). That is, the frame 1120 may at least partially surround the mid-layer 1140 along the outer perimeter of the mid-layer, but because of the relative thicknesses, the mid-layer 1140 may be exposed above and below the frame 1120. In an aspect, first and second core portions 1211, 1212 of a core 1110 may be engaged to these exposed regions of mid-layer 1140, e.g., to a surface thereof and/or wholly or partially enveloping the mid-layer 1140. Thus, unlike other example aspects described herein, the paddle 1000 may include a mid-layer 1140 that protrudes from a paddle structure defined by the frame 1120, rather than forming a base of a cavity within a paddle structure. An edge guard 1050 may be present that surrounds the junctions formed by this configuration on the sides of the paddle 1000, where FIG. 11 shows a view without the edge guard 1050 for clarity and understanding.

FIG. 12 shows an enlarged elevation view showing the arrangement of the core portions 1211, 1212, the frame 1120, and the mid-layer 1140 as viewed from a side of the paddle 1000. The shading in FIG. 12 is used to indicate like parts, and is not indicative of any specific materials, surface finish, texture, or the like. As shown, the frame 1120 surrounds the mid-layer 1140, but portions of the mid-layer 1140 are exposed above and below the frame 1120. Although not shown here, one or both of the first and second core portions 1211, 1212 may be configured to envelop the exposed portions of the mid-layer 1140.

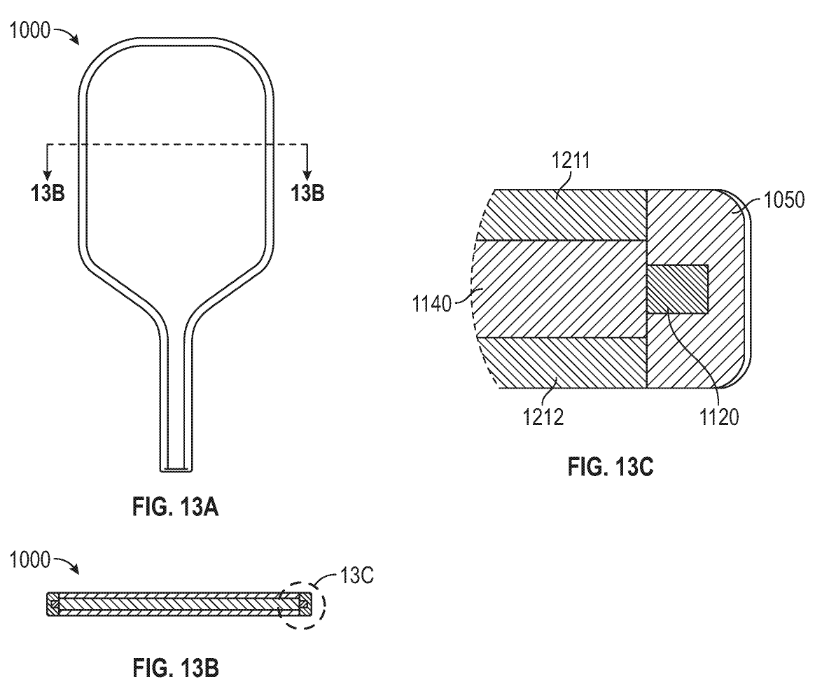

FIG. 13A–13C show, respectively, a plan view, a cross-sectional view, and an enlarged detail view of the structure of pickleball paddle 1000 of FIG. 10, according to a representative example. As shown in the cross-sectional view of FIG. 13C, the frame 1120 may be placed about the paddle structure, such that it is adjacent to the mid-layer 1140. An edge guard 1050 may surround the frame 1120. As shown in the figure, the edge guard 1050 may abut one or more of a first and second core portion 1211, 1212 and the mid-layer 1140. Also or instead, part of the edge guard 1050 may overlay one or more of these components.

The mid-layer 1140 may be disposed between core portions and/or exterior surfaces (playing surfaces) of the paddle 1000. By way of example, a first core portion 1211 and a second core portion 1212 are shown sandwiching the mid-layer 1140 (where one or both of these core portions is coupled to the mid-layer 1140). These core portions may include a playing surface, e.g., a removable and replaceable playing surface. Also or instead, a playing surface may be coupled with a core portion, e.g., to form a removable and replaceable substrate portion that also includes a playing surface thereon.

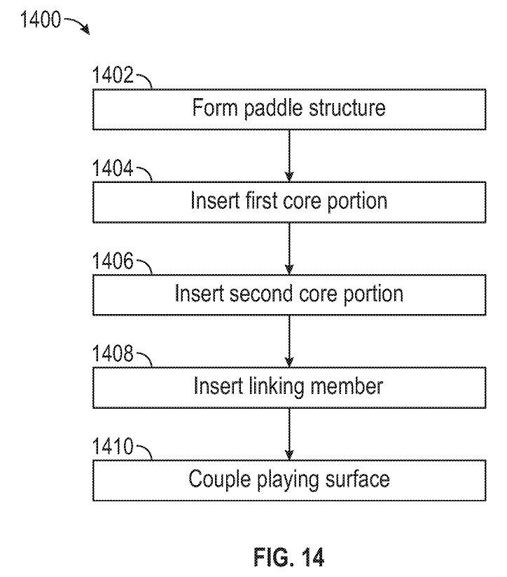

FIG. 14 shows a flow chart of a method 1400 for forming a pickleball paddle, according to a representative example. The method 1400 may include a series of steps for constructing a paddle with various components—e.g., any one or more of the paddles described herein.

As shown in step 1402, the method 1400 may include forming a paddle structure. The paddle structure may include a frame, a mid-layer, and one or more cavities. The mid-layer may be bounded by the frame and disposed at least partially along a plane intersecting opposing sides of the frame. That is, the mid-layer may be disposed along a centerline running longitudinally through the frame. The mid-layer may define a first engagement surface along a front side of the paddle structure and a second engagement surface along a back side of the paddle structure (e.g., as shown in FIGS. 1–2, the side of the mid-layer 240 facing front side 102 may be a first engagement surface and the side of the mid-layer 240 facing back side 103 may be a second engagement surface).

The first cavity may be present along the front side of the paddle structure, and the second cavity may be present along the back side of the paddle structure. In certain aspects, the first cavity may be at least partially bounded by the frame and the first engagement surface of the mid-layer, and the second cavity may be at least partially bounded by the frame and the second engagement surface of the mid-layer. This configuration may create a space within the paddle structure for receiving additional components—e.g., forming indents or cavities to receive other components of the paddle, including internal and/or external components.

As shown in step 1404, the method 1400 may include inserting a first core portion within the first cavity and engaging the first core portion to the first engagement surface of the mid-layer. The first core portion may thus be structurally configured to fit, wholly or partially, within the first cavity of the paddle structure.

As shown in step 1406, the method 1400 may include inserting a second core portion within a second cavity and engaging the second core portion to a second engagement surface of the mid-layer. The second core portion may thus be structurally configured to fit, wholly or partially, within the second cavity of the paddle structure.

Steps 1404 and 1406 may further include coupling or otherwise securing the core portions with the engagement surfaces of the mid-layer. This may include any of the techniques described herein including without limitation one or more of: an adhesive or glue, tape, hook and loop fastening, snap-fit connection, friction-fit connection, one or more magnets (e.g., coupled to components, embedded within components, or defining a material of the components), a clamp, a clip, a dowel, mechanical keying, interlocking features, a latch, a nail, a pin, a rivet, a screw, a slider, a spike, and the like.

In certain aspects, the core portions may form part of the exterior surface on the front side of the paddle. Alternatively, the core portions may be covered by a separate exterior surface component. The core portions may be removably and replaceably coupled with the mid-layer. This configuration may allow for easy replacement or modification of the core portions without necessitating replacement of the entire paddle structure.

In certain aspects, the first core portion and the second core portion may be different. For example, the first core portion and the second core portion may have different materials, densities, thicknesses, or other physical properties. In other aspects, the first core portion and the second core portion may be the same.

As shown in step 1408, the method 1400 may include inserting a linking member (or other structure and/or filler(s)) within a gap formed between at least one of: the first core portion and the frame, and the second core portion and the frame. The linking member may be disposed within at least a portion of the gap to provide a connection between various components of the paddle structure. In other aspects, other materials or fillers may be inserted within such a gap. The gap may also or instead be left devoid of material, or there may not be any gaps at all in the paddle structure.

Thus, in certain aspects, a gap may be formed along each of the front side and the back side of the paddle. A first linking member may be disposed in the gap on the front side of the paddle, while a second linking member may be disposed in the gap on the back side of the paddle. The first linking member and the second linking member may be substantially the same or may have different properties, allowing for customization of paddle performance characteristics on each side. The linking member may be constructed from materials selected to provide specific performance characteristics. For example, the linking member may be made from materials with different properties than the frame or the exterior surface, allowing for customization of the paddle’s flex, vibration dampening, and/or energy transfer characteristics. In certain aspects, the linking member may be bonded to both the frame and/or other components of the paddle using various methods, such as adhesive bonding, mechanical fastening, chemical bonding, and the like. In certain aspects, the linking member may be removable and replaceable.

As shown in step 1410, the method 1400 may include coupling a playing surface to one or more of the first core portion and the second core portion. In certain aspects, the playing surface may be removably and replaceably coupled to at least one of the first core portion and the second core portion. The coupling of the playing surface to the first core portion and/or the second core portion may be achieved through various means, such as any as described herein for coupling the core portions to the mid-layer or otherwise. For example, in certain aspects, adhesive bonding may be used to secure the playing surface to the core portions. Alternatively, mechanical fastening methods or interlocking designs may be employed to facilitate secure attachment while allowing for potential future removal or replacement of the playing surface. The removable and replaceable nature of the playing surface may provide several advantages. For example, worn or damaged playing surfaces may be replaced to extend the lifespan of the paddle. Additionally, players may swap out playing surfaces with different properties to customize the paddle for specific playing conditions or personal preferences. This modularity may enhance the versatility and longevity of the paddle.

In certain aspects, the paddle may be provided as part of a kit that includes one or more playing surfaces, and/or one or more core portions. The playing surfaces may be couplable to at least one of the first core portion and the second core portion, in an example. The kit may allow users to customize their paddle by selecting and attaching different playing surfaces to suit their preferences or playing conditions.

In certain aspects, the method 1400 may result in a paddle with a mid-layer that provides predetermined characteristics for the paddle, e.g., a desired flexibility or stiffness. The mid-layer may thus influence the overall flex and responsiveness of the paddle during play. By selecting materials with specific properties for the mid-layer, and/or by shaping the mid-layer in a specific manner or configuration, the characteristics of the paddle may be tailored to suit different playing styles or preferences.

A potential use case for the method 1400 may involve a pickleball equipment manufacturer creating a line of customizable paddles. The manufacturer may offer a range of mid-layers with varying properties, different core materials, and multiple options for playing surfaces. Players may then select the combination of components that best suits their playing style, potentially resulting in a paddle optimized for power, control, or a balance of both. The manufacturer may also offer replacement components, allowing players to refresh or modify their paddles as needed without purchasing an entirely new paddle.

An aspect of the present teachings includes a kit, which may feature one or more of the paddles (or features/components thereof) described herein. For example, a kit for a paddle may include: a paddle structure, a first core portion, and a second core portion.

The paddle structure may include a frame and a mid-layer bounded by the frame, directly or indirectly. The mid-layer may be disposed along a plane intersecting opposing sides of the frame—e.g., along a centerline of the frame between opposing sides of the frame. In some aspects, the mid-layer may be thinner than the frame (along at least a region thereof, such as an engagement surface) such that it defines a first cavity having a first engagement surface along a front side of the paddle structure and a second cavity having a second engagement surface along the back side of the paddle structure. The first cavity and the second cavity may be wholly disposed within a head portion of the paddle structure in an example aspect. In such aspects, the frame may enclose the head portion of the paddle structure.

The first core portion may be insertable within at least the first cavity and engageable with the first engagement surface, and the second core portion may be insertable within at least the second cavity and engageable with the second engagement surface. In an aspect, the first core portion and the second core portion are substantially the same. In another aspect, the first core portion and the second core portion are different. One or more of the first core portion and the second core portion may define a playing surface for the paddle. Alternatively, the kit may include one or more playing surfaces.

Playing surfaces included within the kit may be couplable to at least one of the first core portion and the second core portion. For example, playing surfaces may be removably and replaceably coupled to at least one of the first core portion and the second core portion.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. For example, regarding the methods provided above, absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A paddle, comprising:
a frame;
a first core portion on a front side of the paddle, the first core portion at least partially bounded by the frame;
a second core portion on a back side of the paddle disposed opposite the front side, the second core portion at least partially bounded by the frame; and
a mid-layer disposed between the first core portion and the second core portion, the mid-layer having one or more different properties than each of the first core portion and the second core portion.

2. The paddle of claim 1, wherein the mid-layer extends from the frame.

3. The paddle of claim 2, wherein the frame bounds an entire perimeter of the paddle, and wherein the mid-layer is present within an entirety of an area bounded by the frame.

4. The paddle of claim 1, wherein the mid-layer is present within a head portion of the paddle.

5. The paddle of claim 1, wherein the mid-layer is present within a handle portion of the paddle.

6. The paddle of claim 1, wherein the mid-layer includes one or more voids.

7. The paddle of claim 1, wherein the mid-layer is more rigid than each of the first core portion and the second core portion.

8. The paddle of claim 1, wherein the mid-layer is more elastic than each of the first core portion and the second core portion.

9. The paddle of claim 1, further comprising a gap formed between at least one of: (i) the first core portion and the frame, and (ii) the second core portion and the frame.

10. The paddle of claim 9, further comprising a linking member disposed within at least a portion of the gap.

11. The paddle of claim 1, wherein one or more of the first core portion and the second core portion is removable and replaceable.

12. The paddle of claim 11, wherein one or more of the first core portion and the second core portion is removably and replaceably coupled with the mid-layer.

13. The paddle of claim 1, wherein the first core portion and the second core portion are different.

14. The paddle of claim 1, wherein one or more of the first core portion and the second core portion defines an exterior surface structurally configured to be a playing surface for the paddle.

15. A method of forming a paddle, the method comprising:
forming a paddle structure comprising:
a frame;
a mid-layer bounded by the frame and disposed at least partially along a plane intersecting opposing sides of the frame, the mid-layer defining a first engagement surface along a front side of the paddle structure and a second engagement surface along a back side of the paddle structure;
a first cavity along the front side of the paddle structure, the first cavity at least partially bounded by the frame and the first engagement surface of the mid-layer; and
a second cavity along the back side of the paddle structure, the second cavity at least partially bounded by the frame and the second engagement surface of the mid-layer;
inserting a first core portion within the first cavity and engaging the first core portion to the first engagement surface of the mid-layer; and
inserting a second core portion within the second cavity and engaging the second core portion to the second engagement surface of the mid-layer.

16. The method of claim 15, further comprising coupling a playing surface to one or more of the first core portion and the second core portion.

17. A kit for a paddle, the kit comprising:
a paddle structure comprising a frame and a mid-layer bounded by the frame, the mid-layer disposed along a plane intersecting opposing sides of the frame, and the mid-layer thinner than the frame such that it defines a first cavity having a first engagement surface along a front side of the paddle structure and a second cavity having a second engagement surface along a back side of the paddle structure;
a first core portion insertable within at least the first cavity and engageable with the first engagement surface; and
a second core portion insertable within at least the second cavity and engageable with the second engagement surface.

18. The kit of claim 17, wherein one or more of the first core portion and the second core portion define a playing surface for the paddle.

19. The kit of claim 17, further comprising one or more playing surfaces, wherein the one or more playing surfaces are couplable to at least one of the first core portion and the second core portion.

20. The kit of claim 17, wherein the first core portion and the second core portion are different.
